(19) United States
(12) Patent Application Publication
(10) Pub. No.: US 2009/0148801 A1
(43) Pub. Date: Jun. 11, 2009

(54) METHOD FOR THE CONTROLLED GENERATION OF HEAT AND CORRESPONDING DEVICE

(76) Inventor: Lothar Wedermann, Leipzig (DE)

Correspondence Address: WHITE & CASE LLP;PATENT DEPARTMENT, 1155 AVENUE OF THE AMERICAS, NEW YORK, NY, 10036, US

(21) Appl. No.: 11/719,507

(22) PCT Filed: Nov. 14, 2005
(86) PCT No.: PCT/EP2005/012162

§ 371 Date: Jun. 20, 2007

(30) Foreign Application Priority Data
Nov. 17, 2004 (DE) 20 2004 017 817.6

(51) Int. Cl. F27B 17/00; A47J 37/07

(52) U.S. Cl. 432/14; 126/25 B

(57) ABSTRACT

According to the invention, there is a method for the controlled generation of heat, which is characterized in that charcoal is kept in a glowing state in an essentially closed-off glow chamber which has at least one fine-mesh screen-like wall for radiating the heat, and there is also a heat source with a charcoal bowl, in particular for carrying out the method, which is characterized by an essentially topside cover with a fine-mesh screen and by at least one ventilation orifice, into which issues in a lower region of the charcoal bowl an air supply line to which an air stream generator, in particular a blower, can be connected.

The present invention relates to a method for the controlled generation of heat and to a device for carrying out the method, in particular a heat source having a charcoal bowl.

Fire and glowing embers have served humankind as a heat source, especially also for cooking, for a long time. Technology has developed a diversity of devices and methods for these purposes. Merely as an example, central heating systems or chimney ovens heat our houses, and we cook on gas or electric stoves. Moreover, we human beings still cannot get away from the fascination with glowing embers and fire. We find the heat from a wood fire comfortable, and on fine days barbecues are a favorite leisure activity.

This direct utilization of burning or glowing wood as a heat source has the disadvantage of extremely low efficiency. For example, the chimney ovens already mentioned have been devoted, inter alia, to this problem and can heat with very considerably increased efficiency. However, such efficiency-improved devices are, as a rule, technically complex, with all the resulting disadvantages, that is to say, for example, are very costly and complicated in terms of production.

The abovementioned problem of low efficiency becomes drastically and tragically clear in the burning of wood, especially also in critical regions of the third world, where inadequately fed people deforest entire belts of land in their distress as protection against cold and because there is no other possibility of cooking, this happening especially in areas where wood is in any case rare because of drought.

The object on which the present invention is based is to provide a method for the controlled generation of heat and a device for carrying out the method, which are improved in a simple way and in efficiency.

This object is achieved by a method having the feature of claim 1 and a device having the features of claim 10 or 11. Preferred refinements are specified in the subclaims.

This application claims the priority of German utility model publication DE 20 2004 017 817 U1, the entire disclosure content of which is also an integral part of this application.

According to the invention, a method for the controlled generation of heat is characterized in that charcoal or another coal-like fuel, which can be produced, for example, by pyrolysis or calcination (only ever designated below by way of example as “charcoal”), is kept in a glowing state in an essentially closed-off glow chamber. Owing to the essentially closed-off glow chamber, the glowing charcoal can be surrounded so securely that the glow chamber can even tip over, without glowing embers which fall out putting the surroundings at risk. Moreover, however, the essentially closed-off glow chamber also has the effect that the heat radiation of the glowing embers is directed predominantly through a fine-mesh screen-like wall of the glow chamber. This is because, even when the glow chamber is produced, for example, from sheet metal (for example, high-rate steel or tinplate) and therefore heats up itself and transports heat, the fine-mesh screen will let heat pass through in greater quantity. Since the piece diameter of the charcoal in the glow chamber preferably lies essentially below 25 mm, the charcoal can be kindled very simply and quickly (with low energy). A very handy glow chamber can also be designed for this piece size of the charcoal. The glow chamber is preferably filled with a charcoal portion of approximately 150 grams. This is sufficient for a glow duration of approximately 30 to 60 minutes on account of the controllable airflow.

Other sizes of the glow chamber may be instigated according to the invention. The volume and configuration of the glow chamber may therefore be appropriately designed or adapted variably to varied requirements and/or set objects and to the desired burning duration. The combustion chamber in the system may thus also be larger or smaller.

Particularly preferred for the method according to the invention is charcoal which has the following constituents: 40% to 60% of the charcoal with a piece diameter of 5 mm to 20 mm, 40% to 60% of the charcoal with a piece diameter of 20 mm to 25 mm and, at most, a small residue of smaller fragments and dust which occur, for example, during transport. Of this, half the charcoal having smaller pieces makes ignition easier, while the other half of the charcoal having the larger pieces promotes the glowing duration.

Preferably, the glow in the glow chamber can be intensified by the supply, directed particularly by means of a line, of an airflow into the glow chamber. If, therefore, according to the invention, the glow is blown upon by means of a hairdryer or an electric blower, or else by means of a blower operated by a crank handle, in order truly to be completely independent of electrical energy, for example in critical areas, the glow becomes hotter and the radiated energy increases. As soon as the airflow is terminated again, “the glow goes to sleep”, and it cools, but without being extinguished completely, and can therefore also be kindled again into greater heat by a renewed delivery of air. It is particularly preferable to set the intensity of the airflow, either, for example, by setting a higher blower stage or by faster cranking, but a continuous adjustability of the blower power or, more generally, of the velocity of the airflow may also be envisaged electrically.

It is particularly preferable, furthermore, to kindle the glowing embers in the glow chamber by an ignition means which is ignited or inflamed in the vicinity of the charcoal and the heat of which is conducted overall, by means of an airflow, in particular the airflow with which the glow can also be intensified, to the charcoal in the glow chamber. The ignition means may be pyrotechnic, for example in the manner of matchheads, although in a larger quantity of this material. Ignition means according to the invention either may be produced specially, or finished products, such as, for example, a sparkler, may also be used. However, other known easily inflammable, solid, pyrotechnic or liquid substances and mixtures may also be envisaged as ignition means. Thus, for example, paraffin, even grated, has also been shown to be suitable. In particular, it is advantageous, according to the invention, that, because of the low energy requirement, a small quantity of ignition means is sufficient for kindling the charcoal. The ignition means is preferably ignited in an ignition chamber adjacently to the glow chamber, preferably near the charcoal, and the heat of the ignition means is conducted to the charcoal.

Particularly for carrying out this method according to the invention, the heat source according to the invention has an essentially closed-off glow chamber which has at least one fine-mesh screen-like wall for radiating the heat. The heat source preferably comprises a charcoal bowl with an essentially topside cover with a fine-mesh screen and also at least one ventilation orifice in a lower region of the charcoal bowl. An air supply line, to which an air stream generator can be connected, issues into the ventilation orifice from outside. For example, a hairdryer can be plugged from outside as an air stream generator onto the air supply line. However, a blower may be integrated or built directly into the device and thus supply the air supply line with an airflow.

The heat source preferably has an ignition chamber for an ignition means, as described above by way of example. The ignition chamber is arranged near the charcoal bowl and issues through at least one ignition orifice into a lower region of the charcoal bowl. However, a plurality of nozzle-like ignition orifices are preferred, through which the air heated by the inflamed ignition means is conducted with an increased velocity and pressure into the charcoal in order to kindle this. The at least one ventilation orifice is also preferably nozzle-like.

Particularly preferably, the air supply line runs through the ignition chamber. Then, to be precise, the ventilation orifices which lead out of the air supply line into the charcoal bowl may also serve as ignition orifices. Moreover, the airflow conducted through the air supply line from outside may serve, on the one hand, during the kindling of the embers, to conduct the heat of the ignition means to the charcoal and, on the other hand, later, to intensify the heat of the glow, once the charcoal is kindled.

A pan for the ignition means is preferably arranged in the ignition chamber. If the air supply line runs through the ignition chamber, the airflow from the air supply line preferably does not flow directly through this pan, but swirls through it, to be precise, for example, in that the airflow sweeps around the pan from below upwardly passed the pan edge and at the same time swirls over the pan edge into the pan. This pan is suitable particularly for small quantities of paraffin in small pieces, for example grated paraffin.

Air conduction beneath the heat source to a shallow chamber is preferably increased. The airflow conducted through there cools this region and thus advantageously ensures that the heat source can be set down even on heat-sensitive bases, because it scarcely heats up or even does not heat up at all on the underside.

The heat source according to the invention is to be used particularly preferably for grilling devices, by means of which foodstuffs, such as, for example, meat or fish, can be cooked. Thus, according to the invention, a grilling device may have the heat source according to the invention, the grilling device having an essentially horizontal grilling grid, beneath which is located the glow chamber having an essentially topside cover consisting of a fine-mesh screen. Preferably, between the cover of the charcoal bowl with a fine-mesh screen and the grilling grid, there is a distance of at least a few centimeters. Preferably, further, the heat source is contained in an outer insulating bowl which surrounds the heat source so as to be spaced apart by the amount of an air space. As a result, the grilling device does not become hot on the outside. There is therefore no risk of burning there even in the event of inadvertent contact. The grilling grid then lies above the heat source, preferably on the outer insulating bowl and, as it were, forms the lid of the latter. The grilling grid can then be fastened to the outer insulating bowl particularly preferably (releasably), so that even tipping over scarcely constitutes any risk of burning, because the grilling device remains together as a structural unit, and, according to the invention, the glowing charcoal in the glow chamber, being in any case safely surrounded, is prevented from falling out. Overall, therefore, according to the invention, a heat source or a grilling device which can be operated cleanly, safely and quickly is obtained.

Further advantages, refinements and details of the invention are described below with reference to the accompanying figures in which:

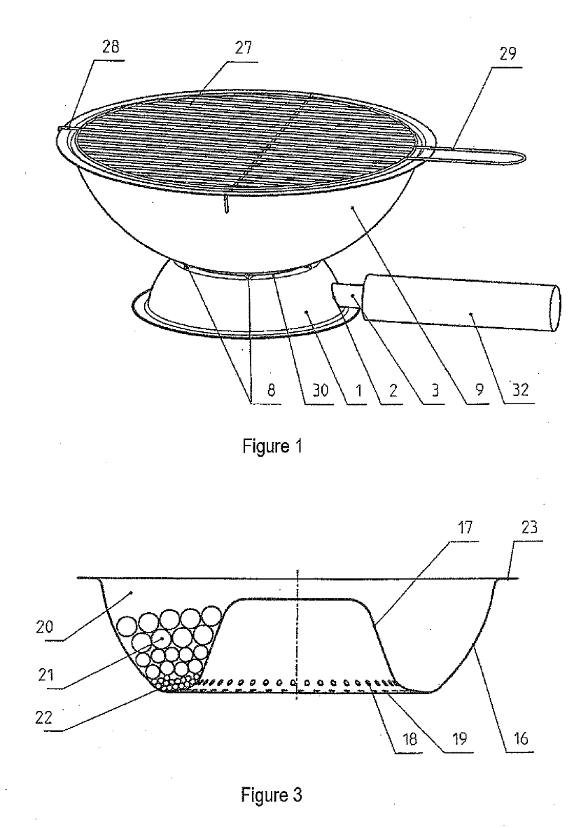

FIG. 1 shows a three-dimensional view of a grilling device according to the invention,

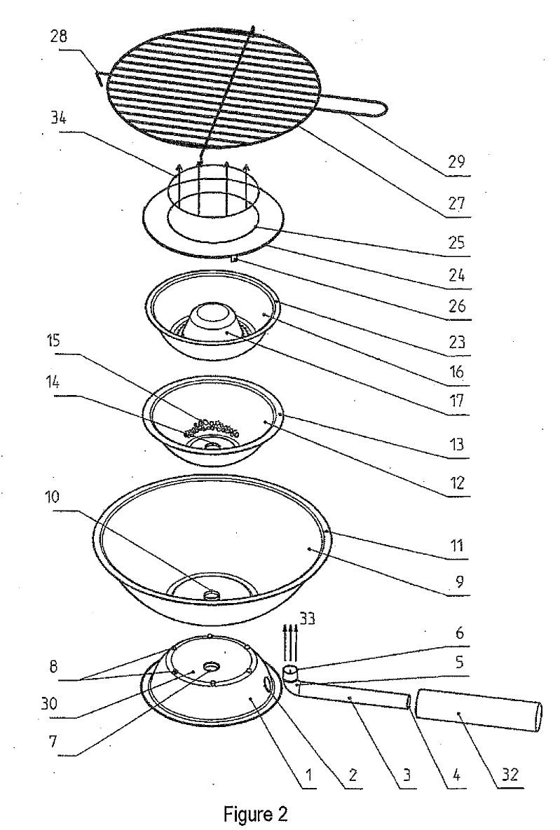

FIG. 2 shows an exploded illustration of the device according to FIG. 1,

FIG. 3 shows a sectional side view through the charcoal bowl of the device according to FIGS. 1 and 2,

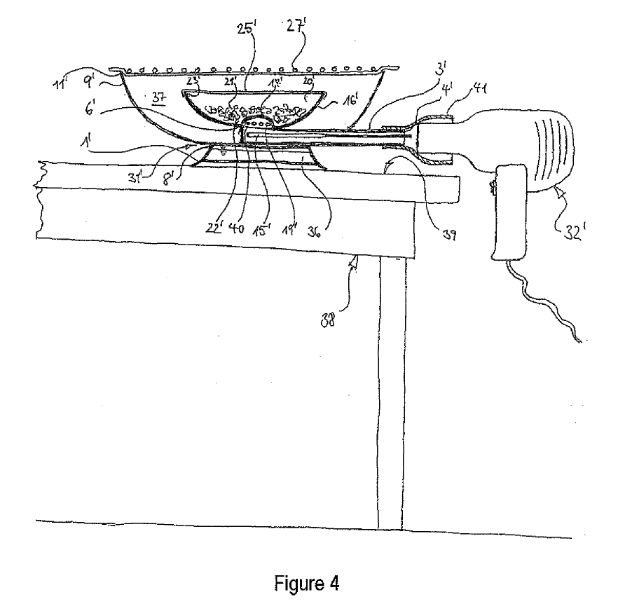

FIG. 4 shows a sectional side view of an alternative grilling device according to the invention, and

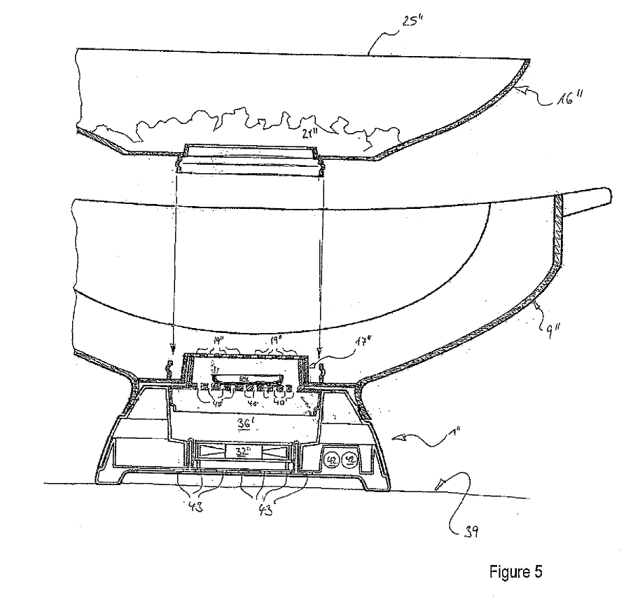

FIG. 5 shows a sectional side view of another alternative grilling device according to the invention.

The device according to FIGS. 1 to 4 is constructed predominantly, using prefabricated, preferably rotationally symmetrical parts consisting of thin high-grade sheet steel. However, according to the invention, any other configuration may also be envisaged. The rotationally symmetrical forms illustrated are nevertheless advantageous on account of simplicity in manufacturing terms and costs. As can be seen, even high-grade steel bowls obtainable as a product can be used for some of the components depicted, and then only finishing steps are required. Execution in high-grade steel also conforms to current stipulations with regard to hygienic provisions and allows a simple cleaning of the device which can then also be dismantled for this purpose.

The set-up of the device according to the invention will first be described by way of example with reference to FIG. 2.

A circular perforation 2 which serves for receiving an air delivery pipe 3 is introduced into the wall of a rotationally symmetrical foot 1. A combustion air stream generator 32 for generating a combustion air stream 33 can be plugged onto the free end 4 of said air delivery pipe. The front end of the air delivery pipe 3 is shaped as a pipe angle 5 and carries a threaded connection piece 6 of a closing system. This is plugged through a central perforation 7 of the foot 1 and, via likewise central perforations 10 and 14, receives in this a carrier bowl 9 and a reception bowl 12 which is provided centrally with a closing system.

With this reception bowl 12 being placed onto the threaded connection piece 6 and with the closing system 6, 14 being actuated, the device is assembled and is mechanically stable and steady. According to the invention, an interspace 31 with respect to the carrier bowl 9 is formed by means of bosses 8 pressed upward into the plane surface 30 of the foot 1. Consequently, according to the invention, a possible heat transfer from the carrier bowl 9 to the foot 1 is restricted to the minimum of the transmitting heat bridge surfaces of the bosses 8, and, according to the invention, the operative principle of cup springs of the mounted parts 1, 9 and 12 is utilized such that the parts 1, 9 and 12 joined by means of the nonpositive connection 6, 14 form a mechanically stable structural unit.

The reception bowl 12 serves for receiving a quantity of kindling aid 15, for example grated paraffin, a liquid grill kindling aid or preferably pyrotechnic ignition means either in granulate form or preferably adhering around a wire or another carrier material (such as, for example, in the case of a sparkler). This reception bowl 12 receives a charcoal reception bowl 16 which surrounds a combustion space 20 in which a charcoal heap 21 is located. This charcoal reception bowl 16 has a central conical protuberance 17 which is directed inward and upward and in the lower inner circumference of which nozzle-like perforations are introduced in one or more concentric hole circles 18 and 19. In this conical protuberance 17, a build-up of the combustion air stream enriched with energy by the ignition means occurs, as a result of which this combustion air stream swirls around and ignites the charcoal heap 21 through the nozzle-like perforations 18, 19 in the combustion space 20. Also, in another embodiment of the invention, this form of this conical protuberance 17 can be selected such that charcoal pieces which are not yet burnt slip down constantly.

In a further refinement of the invention, this charcoal reception bowl 16 is manufactured from expanded metal, so that the throughput of the combustion air stream 33 takes place over the entire surface of the charcoal reception bowl 16, the “roof” of the conical protuberance 17 being covered with a cap.

Arranged over an edge 23 of the charcoal reception bowl 16 is a flame screen 24 on which a fine-mesh rest 25 is applied centrally and is retained resiliently by means of resilient claws 26 over the edges 13 of the reception bowl 12 and 23 of the charcoal reception bowl 16. The combustion space 20 is consequently closed off firmly in mechanical terms and safely. It is virtually impossible, even if the device were to tilt or even tip over or fall over, for the charcoal heap 21, together with the hazardous glowing embers 22 possibly contained in it, to fall out of the combustion space 20, and, when the device is in the operating state, a throughput of radiant heat through the screens 24, 25 is ensured.

According to the invention, this design of the flame screen also prevents the feared flying sparks and the licking of flames in the event of grease dripping through.

A grilling grid 27 with holding bars 28 is retained on the edge 11 of the carrier bowl 9 such that the entire device can be tilted by a holding grip 29 of the horizontal operating position into a vertical position, but also into any other oblique position, and can be safely transported in any of these positions, even when the charcoal heap 21 is in the glowing state, since, of course, in particular, the glowing embers are held, safely surrounded, in the glow chamber essentially closed off by means of the screens 24, 25. In such a tilted state (not illustrated), the device can also be used, for example, as a heating appliance, according to the invention the radiant heat 34 even being additionally directed through the carrier bowl 9 as a reflector. According to the invention, the dimensioning of the reception bowl 12 and of the carrier bowl 9 is coordinated such that an air space is formed between these two bowls. What is achieved thereby is that energy is transmitted from the reception bowl 12 to the carrier bowl 9 over only a small contact surface, and that the reflector properties of the carrier bowl 9 and of the inner bowl 12 in the direction of the grilling grid 27 are fully utilized. Consequently, possible heating on the bottom of the carrier bowl 9 in the immediate vicinity of its central perforation 10 is limited, and the remaining part, up to the edge 11, is at ambient temperature, so that the risk of burning for the operator and for the surroundings is virtually ruled out. This device therefore also even fulfills the preconditions for use in closed spaces and even directly on a meal table, even on a wooden tabletop. The safety distance then needs to be adapted merely to human heat sensitivity.

To change its location, with the food to be cooked placed on the grilling grid 27, the device can be safely grasped by the user on all the outer regions of the foot 1, the carrier bowl 2 and the air delivery pipe 3, while the air delivery pipe 3 may serve as a handle for carrying the device freely.

To operate the device depicted, there is a combustion air stream generator 32. In an application according to the invention, this is a hot-air dryer which can be plugged onto the free end 4 of the air delivery pipe 3 by means of an adapter. By means of such an appliance, the charcoal heap 21 can be ignited even without the use of a kindling aid 15.

To operate the device, only small combustion air quantities in combustion air streams 33 of low flow velocity are required. However, these should be easily adjustable.

Particularly for operating the heat source according to the invention where electrical energy from plug sockets or batteries is scarcely available, particularly in critical regions, the combustion air stream generator 32 may even be operable by means of a crank handle (not illustrated) as an accessory according to the invention.

A highly elegant solution for a combustion air stream generator 32 is a blower of very small type of construction which is operated by means of a built-in battery. It is also conceivable to operate this from the power supply via a mains cable. Even a hair dryer can be used. The blower may also be integrated or built in directly, for example, into a foot or pedestal of the heat source. Then, depending on the energy supply, either a battery compartment or a cable with a plug is provided in the device.

As a particularly simple alternative solution, a person can also generate the combustion air stream 33 with his breath by means of a hose plugged onto the pipe 3. Operation by an air pump worked by muscular power or with bellows, which for safety reasons should in each case be provided with a nonreturn valve, so as not to suck air back again through the air delivery pipe 3, may also be envisaged. Owing to this possible independence of the device from secondary energy sources, therefore, it is possible for the device to have worldwide universal use even in regions of poverty.

Cooking processes by roasting are based on the direct action of the radiant heat of an open energy source on the food to be cooked.

According to the invention, this physical process is implemented in that, in a first phase, commencing with the ignition of the kindling aid 15 and consequently the generation of an energy-enriched air stream, the charcoal heap 21 is first kindled, until a brief natural generation of smoke has ended. To inflame the charcoal heap 21, it is not absolutely necessary for it to be dry, that is to say even dampened or soaked charcoal is ignited, in particular, by means of the energy-enriched air stream. The combustion air stream 33 is controlled such that the charcoal heap 21 is kindled only in its lower layer and a glowing bed 22 is generated there. During a second phase which then follows, an only weak combustion air stream 33 is sufficient to maintain this glowing bed 22 and consequently to generate the radiant heat 34 required for the start of a cooking process. By the combustion air stream 33 being controlled, the radiant heat 34 can be adapted at any time to the energy requirements of the cooking process. During this combustion process, the charcoal heap 21 can slip down as a result of the shaping according to the invention of the charcoal reception bowl 16, so that there is always a sufficient supply of this energy carrier above the glowing bed 22

The interaction of the arrangement according to the invention of the flame screen 24 with the rest 25 and the reflector properties of the carrier bowl 9 ensures an equalized distribution of the radiant heat 34 beneath the grilling grid 27 and consequently a uniform cooking of the food to be cooked which is located on this.

In a further function according to the invention, the combustion air stream 33 is switched off when the cooking process is to be temporarily ended. According to the invention, in such a phase, the flame screen 24 fulfills the function which an ash layer can assume in a fire. To be precise, it prevents the further supply of combustion air from above, of which the penetration into the combustion space 20 is prevented, furthermore, by the rising radiant heat 34. Since, in this phase, there is also no follow-up of combustion air stream 33 from the combustion air stream generator 32, the glowing embers cool down somewhat and “go to sleep”.

This state is maintained for some time. However, by the renewed supply of a combustion air stream 33, the glowing embers can also be rekindled to full power at any time. The complete combustion of the charcoal heap 21 is consequently possible. Even if the glowing embers are extinguished completely because of a lack of a supply of combustion air, charcoal residues can be utilized again when the device is put into operation once more.

In this state, but also in the operating state assisted by an airflow, the device can be utilized virtually safely for the purpose of heating in order to utilize the radiant heat 34 and, since the generation of exhaust gases is restricted to a minimum, can be employed virtually safely even in closed spaces.

In a further useful application, a cooking vessel, for example a cooking pot, can be placed selectively on the flame screen 24 or onto the grilling grid 27. The device then likewise functions in the way described and can therefore also serve as a cooking point.

It is possible, according to the invention, to dimension the device in various sizes, so that different demands as regards the quantities of food to be cooked simultaneously can be fulfilled. Thus, for example, a grilling device according to the invention may be designed which is just sufficiently large to grill a steak or a couple of small sausages even for only one person, but a gastronomy grill according to the invention also affords the advantages according to the invention. In particular, such a larger grill could also advantageously in manufacturing terms be designed to be not only rotationally symmetrical, but also in elongate (to use a term from computer aided design: extruded), for example even mirror-symmetrical form.

FIG. 4 shows an alternative embodiment of a grill according to the invention. In FIG. 4, first, all functionally similar elements and details are numbered, as in FIGS. 1 to 3, without necessarily being directly identical to these. The particularly notable differences from the device according to FIGS. 1 to 3, from which these component differences also arise, are as follows:

According to FIG. 4, the foot 1′ has integrated into it a water container 36 which constitutes, in addition to the interspace 31′, a heat-insulating region beneath the charcoal bowl 16′. Together with the air space 37′ between the charcoal bowl 16′ and the outer insulating bowl (carrier bowl) 91, the water container 36 assists the possibility of also standing the grilling device according to the invention, for example, on a table 38 with a wooden tabletop 39, even with the device according to the invention in operation, without the tabletop 39 being carbonized by the foot 11.

The charcoal bowl 16′, with its topside cover 25′ consisting of a fine-mesh screen, which is snapped over the upper edge 23′ of the charcoal bowl 16′ and holds the charcoal 21′, together with the glowing embers 221, safely surrounded there, is designed as a prefabricated exchangeable module together with the ignition chamber 17′ and with its nozzle-like ignition and ventilation orifices 19′. Together with a suitably weighed-out and suitably granular charcoal portion, this exchangeable module may even also be produced as a prefabricated disposable article and be marketed correspondingly. Where the device according to FIGS. 1 to 3 has the threaded connection piece 6, this module (161, 171, 21′, 251) is designed with a particularly simple actuatable quick-action fastening 61 which can function, for example, by means of magnetic force and/or as a positive sliding or rotating quick-action fastening (bayonet).

According to FIG. 4, the ignition chamber is not designed as a separate bowl (13 in FIG. 1), but, instead, is formed on the topside by the conical or spherically segmental protuberance 17′ in which the ignition and ventilation orifices 19′ are arranged so as to be distributed radially on a circumference. As illustrated, the ignition chamber 17′ issues in the underside as a large-area orifice 40 into that end of the air supply line 3′ which is arranged there. This end of the air supply line 3′ belongs, as it were, to the ignition chamber 171, since the air supply line 3′ is designed as a straight elongate pipe such that an ignited sparkler 15′ can be introduced as ignition means into the air supply line 31. Since the sparkler 15′ has unusually been ignited at its lower end (on the right in the figure) before the user has introduced it into the air supply line 3′, it then burns (to the left in FIG. 4) in the same way as a fuse in the direction of that end of the air supply line 3′ above which the conical ignition chamber protuberance 171 is located.

If, then, a hairdryer 321 as an air stream generator is placed onto the spout-like widening 41 at the free end 4′ of the air supply line 31 and is switched on, it blows an airflow into the air supply line 3′ and thus presses the heat of the sparkler 15′, as pyrotechnic ignition means, through the orifices 19 into the charcoal 21′, so that this is kindled into the glow 22′.

FIG. 5 shows another alternative embodiment of a grill according to the invention. In FIG. 5, too, all functionally similar elements and details are first numbered, as in FIGS. 1 to 3, without necessarily being directly identical to these. The particularly notable differences from the devices according to FIGS. 1 to 4, from which these component differences also arise, are as follows:

According to FIG. 5, the ignition chamber is not designed as a separate bowl (13 in FIG. 1), but, instead, is formed on a topside by a cylindrical protuberance 171′ in which the ignition and ventilation orifices 19″ are located, oriented axially on the topside. On the underside, the ignition chamber 17″ issues through a plurality of likewise axially running small orifices 40′ into a large air chamber 361 through which the airflow from a blower 32″ flows. On account of the cold air flowing through it, the air chamber 36′ insulates the device downward, so that the device can be set down even on a heat-sensitive base 39. The blower 32″ is built into the pedestal or standing foot 1″ and is supplied with power by batteries 42.

The blower 32″ sucks the air from outside into the air chamber 36′ through orifices 43 in the underside of the pedestal 1″ and presses it from there through the orifices 40′ into the ignition chamber 171′. The air sweeps upward there past the edge of a pan 44 and is thus also swirled into the pan 44. Grated paraffin (not illustrated), which can be placed into the pan, is thereby kindled into particularly high heat in order to ignite the charcoal in the charcoal bowl 16″ capable of being placed on top. Since the airflow flows from below through the ignition chamber 17″ upwardly, it does not flow directly through the pan 44, but is only swirled around, as described. Overall, therefore, in this device to FIG. 5 the air supply line 3, 3′ from FIGS. 1 to 4 is reduced to the volumes of the air chamber 36′ and of the blower 32″, commencing at the orifices 43 below the blower.

The charcoal chamber 16″, with the topside wall 25″ in the manner of a fine-mesh screen and preferably also with the air inlets (not illustrated) formed on the underside, is, together with the charcoal heap 21″ contained in it, a prefabricated exchangeable module, for example as a disposable article, which can preferably be plugged positively from above over the ignition chamber 17″ (as indicated by the two arrows). According to the invention, any other releasable types of connection, such as, for example, a screw or magnetic connection, may also be envisaged.

1-26. (canceled)

27. A method for the controlled generation of heat, wherein a charcoal is kept in a glowing state in a closed-off glow chamber which has at least one fine-mesh screen-like wall.

28. The method of claim 27 wherein the charcoal has a piece diameter below 25 mm.

29. The method of claim 27 wherein the heat of the glow is intensified by a supply of an airflow into the glow chamber and is reduced again by the airflow being switched off.

30. The method of claim 29 wherein the heat of the glow is controlled by setting the intensity of the airflow into the glow chamber.

31. The method of claim 27 wherein the charcoal in the glow chamber is kindled by igniting an igniter and conducting the heat of said igniter to the charcoal in the glow chamber by an airflow.

32. The method of claim 31 wherein the igniter is ignited near the charcoal.

33. The method of claim 31 wherein the igniter is ignited in an ignition chamber outside the glow chamber.

34. The method of claim 31 wherein the igniter is selected from a group of a pyrotechnic igniter and grated paraffin.

35. The method of claim 27 wherein the charcoal consists of the following constituents:
40% to 60% of the charcoal with a piece diameter of 5 mm to 20 mm,
40% to 60% of the charcoal with a piece diameter of 20 mm to 25 mm and
a small residue of smaller charcoal fragments and dust.

36. A heat source comprising
a charcoal bowl, having
a topside cover with a fine-mesh screen and
at least one ventilation orifice in a lower region of the charcoal bowl; and
an air supply line connected to an air stream generator that issues into said ventilation orifice.

37. The heat source of claim 36 wherein the air stream generator is integrated with the heat source.

38. The heat source of claim 36 further comprising
an ignition chamber containing an igniter,
wherein the ignition chamber is arranged near the charcoal bowl and issues heat through at least one ignition orifice into the lower region of the charcoal bowl.

39. The heat source of claim 38 wherein the air supply line runs through the ignition chamber, and the ventilation orifices also serve as ignition orifices.

40. The heat source of claim 38 wherein the ignition chamber is configured so that a sparkler can be introduced into said ignition chamber as the igniter.

41. The heat source of claim 38 wherein the ignition chamber further comprises
a pan configured so that the airflow from the air supply line does not flow directly, but swirls.

42. The heat source of claim 36 wherein the charcoal bowl with the screen, charcoal and the ventilation orifices, is designed as a prefabricated exchangeable module.

43. The heat source of claim 38 wherein the ignition chamber with the igniter is designed as a prefabricated exchangeable module.

44. The heat source of claim 36 wherein the charcoal bowl with the screen, charcoal and the ventilation orifices, is designed as a prefabricated disposable module.

45. The heat source of claim 38 wherein the ignition chamber with the igniter is designed as a prefabricated disposable module.

46. The heat source of claim 42 wherein the exchangeable module can be fastened by magnetic force or a positive quick-action fastening.

47. The heat source of claim 43 wherein the exchangeable module can be fastened by magnetic force or a positive quick-action fastening.

48. The heat source of claim 44 wherein the disposable module can be fastened by magnetic force or a positive quick-action fastening.

49. The heat source of claim 45 wherein the disposable module can be fastened by magnetic force or a positive quick-action fastening.

50. The heat source of claim 36 further comprising
a heat-insulating region.

51. The heat source of claim 36 wherein the heat-insulating region is a water container located around the charcoal bowl or beneath the charcoal bowl.

52. The heat source of claim 36 wherein the air line is widened on the underside around the charcoal bowl and beneath the charcoal bowl to form an air chamber.

53. The heat source of claim 36 further comprising
an outer insulating bowl which surrounds at least some regions of the charcoal bowl,
wherein the outer insulating bowl is spaced apart from the charcoal bowl by an air space.

54. The heat source of claim 53 wherein the air stream generator is located outside the insulating bowl and the air supply line connects the air stream generator to the insulating bowl.

55. The heat source of claim 53 wherein the air stream generator is integrated into the insulating bowl.

56. The heating device of claim 36 further comprising a grilling grid above the charcoal bowl.

57. The heating device of claim 53 further comprising a grilling grid covering a top portion of the outer insulating bowl

58. The heating device of claim 57 wherein the grilling grid is releasably fastened to the outer insulating bowl.
